(19) United States
(12) Patent Application Publication
(10) Pub. No.: US 2010/0251161 A1
(43) Pub. Date: Sep. 30, 2010

(54) VIRTUAL KEYBOARD WITH STAGGERED KEYS

(75) Inventors: Jeffrey Fong, Seattle, WA (US); John David Kittell, Seattle, WA (US); Bryan Nealer, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/410,280

(22) Filed: Mar. 24, 2009

(51) Int. Cl. G06F 3/048; G06F 3/02; G06F 3/041

(52) U.S. Cl. 715/773; 345/168; 345/173

(57) ABSTRACT

A computing system includes a touch display and a virtual keyboard visually presented by the touch display. The virtual keyboard includes one or more rows of staggered virtual-touch-input keys. The computing system further includes a touch-to-key assignment module configured to assign a touch directed to the virtual keyboard and recognized by the touch display to a virtual-touch-input key.

### BACKGROUND

Computing devices have been designed with various different input mechanisms that allow a computer user to issue commands and/or input data. While portable devices continue to become more popular, user expectations have increased with respect to the usability and functionality of portable input mechanisms.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to virtual keyboards with staggered keys are disclosed herein. For example, one disclosed embodiment provides for a computing system that includes a touch display and a virtual keyboard visually presented by the touch display. The virtual keyboard includes one or more rows of staggered virtual-touch-input keys. The computing system further includes a touch-to-key assignment module configured to assign a touch directed to the virtual keyboard and recognized by the touch display to a virtual-touch-input key.

### BRIEF DESCRIPTION OF THE DRAWINGS

FIG. 1 shows a handheld computing system visually presenting a virtual keyboard with staggered keys.

FIG. 2 shows an example embodiment of a virtual keyboard with staggered keys.

FIG. 3 shows an arced row of a virtual keyboard with staggered keys.

FIG. 4 shows an example embodiment of a virtual keyboard with staggered keys.

FIG. 5 schematically shows a computing system configured to visually present a virtual keyboard with staggered keys.

FIG. 6 shows staggered-proximity distance measurements for keys of a virtual keyboard with staggered keys.

FIG. 7 shows a key of a virtual keyboard with staggered keys changing appearances responsive to that key being considered ready for selection.

FIG. 8 shows a method of processing user input in accordance with embodiments of the present disclosure.

### DETAILED DESCRIPTION

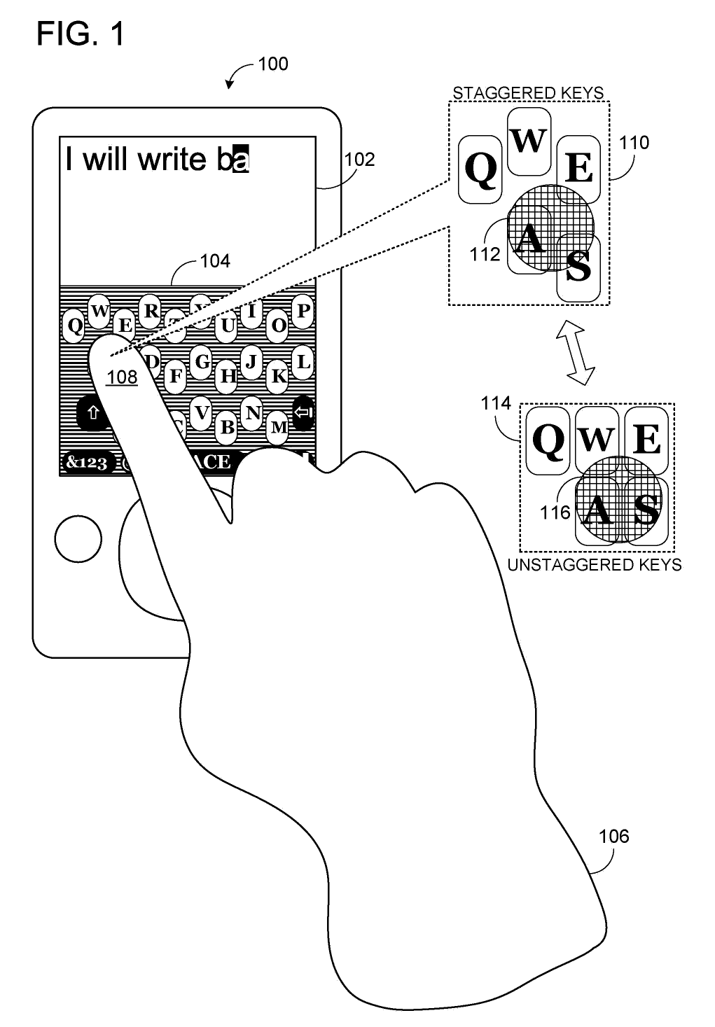

FIG. 1 shows a handheld computing system 100 that includes a touch display 102 visually presenting a virtual keyboard 104. Virtual keyboard 104 serves as a portable input mechanism that allows a user 106 to issue commands and/or input data by touching touch display 102. As an example, a user (e.g., user 106) may touch a key of virtual keyboard 104 (e.g., the A-key) in order to cause data associated with that key (e.g., ASCII “A”) to be recognized as input from the user.

As described in detail below, virtual keyboard 104 includes staggered keys that may facilitate user input. As an example, in embodiments in which the virtual keyboard has a relatively small size, staggered keys may reduce keying errors resulting from large fingers, or other objects used to effectuate touch input, accidentally striking a key that is not intended to be struck. As an example, as shown in FIG. 1, user 106 is touching virtual keyboard 104 with finger 108. As shown at 110, a touch region 112 of finger 108 is overlapping not only a portion of the A-key, but also a portion of the E-key and a portion of the S-key. On a relatively small virtual keyboard, it may be difficult to touch only one key at a time. Furthermore, it may be difficult to touch an intended key before touching unintended keys and/or to lift a finger from an intended key after first lifting the finger from all other unintended keys. As such, it may be difficult for a computing device to accurately resolve which key the user is intending to strike.

As shown at 114 for purposes of comparison, a virtual keyboard without staggered keys may exacerbate potential difficulties in resolving which of two or more touched keys is intended to be selected. In particular, a touch region 116 is shown overlapping a similarly-sized portion of the A-key as compared to touch region 112. However, without staggered keys, touch region 116 overlaps a greater portion of the E-key and the S-key, and now overlaps a portion of the W-key. Therefore, key strike identification may be more difficult with an unstaggered virtual keyboard than with a virtual keyboard having staggered keys.

While FIG. 1 uses handheld computing system 100 as an example platform for illustrating the herein described concepts, it is to be understood that a virtual keyboard with staggered keys may be implemented on a variety of different computing devices including a touch display. The present disclosure is not limited to handheld computing devices. Furthermore, the present disclosure is not limited to the example virtual keyboard embodiments illustrated and described herein. Virtual keyboards may be designed with a variety of different key arrangements, key shapes, key sizes, and/or other parameters without departing from the spirit of this disclosure.

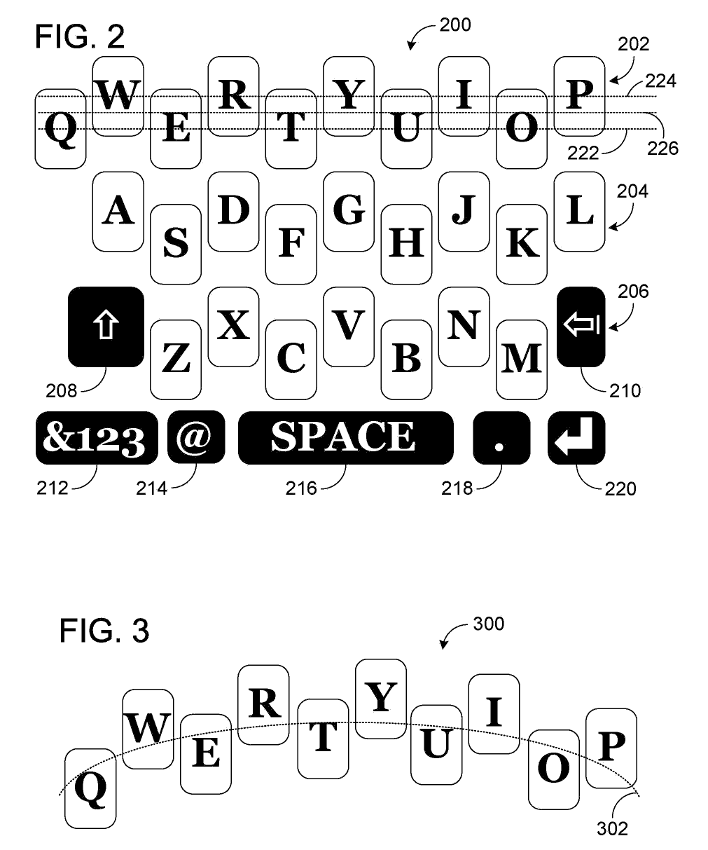

FIG. 2 shows virtual keyboard 200 in more detail. In the illustrated embodiment, virtual keyboard 200 is arranged with a QWERTY key layout. Virtual keyboard 200 includes a top row 202, a middle row 204, and a bottom row 206, each of which includes staggered virtual-touch-input keys. In particular, virtual keyboard 200 includes a top row 202 comprising a left-to-right arrangement of a Q-key, a W-key, an E-key, an R-key, a T-key, a Y-key, a U-key, an I-key, an O-key, and a P-key. Virtual keyboard 200 also includes a middle row 204 comprising a left-to-right arrangement of an A-key, an S-key, a D-key, an F-key, a G-key, an H-key, a J-key, a K-key, and an L-key. Furthermore, virtual keyboard 200 includes a bottom row 206 comprising a left-to-right arrangement of a Z-key, an X-key, a C-key, a V-key, a B-key, an N-key, and an M-key. The illustrated virtual keyboard also includes various other keys, such as a shift-key 208, a delete-key 210, a number-input-key 212, an @-key 214, a space-key 216, a period-key 218, and a return-key 220. It is to be understood that a virtual keyboard may have additional and/or alternative keys while remaining within the scope of this disclosure.

Each row of staggered virtual-touch-input keys includes a first set of keys aligned with a first offset and a second set of keys aligned with a second offset. As an example, in top row 202 the Q-key, the E-key, the T-key, the U-key, and the O-key are aligned with a downward offset 222; while the W-key, the R-key, the Y-key, the I-key, and the P-key are aligned with an upward offset 224. As used herein, the term offset is used to describe a line or other anchor that is spaced apart from a central line or other anchor. For example, downward offset 222 is spaced below average-row-line 226, and upward offset 224 is spaced above average-row-line 226 by an equal distance. The average-row-line or other anchor from which the offsets are spaced may spatially split the distance between the offsets. The offsets may be spaced virtually any distance from the average-row-line. In the illustrated embodiment, the offsets are spaced at approximately 20% of the height of the virtual-touch-input keys. Various different portions of a key may be aligned with an offset, including, but not limited to, a centroid of the key.

As shown in FIG. 2, a row (e.g., top row 202) of staggered virtual-touch-input keys may be a straight row with a straight average-row-line (e.g., average-row-line 226). As shown in FIG. 3, a row 300 of staggered virtual-touch-input keys alternatively may be an arced row with an arced average-row-line 302.

Expanding on the key description of top row 202 of FIG. 2, in virtual keyboard 200 the Q-key, the E-key, the T-key, the U-key, the O-key, the S-key, the F-key, the H-key, the K-key, the Z-key, the C-key, the B-key, and the M-key are aligned with a downward offset; and the other letter keys are aligned with an upward offset. Such an arrangement may be reversed without departing from the scope of this disclosure. Furthermore, in some embodiments, a row may be staggered along three or more different offsets, each spaced a different distance and/or direction from a central anchor or line.

As shown in FIG. 2, virtual keyboard 200 includes at least some staggered virtual-touch-input keys (e.g., the letter keys) that are generally-rectangularly-shaped. In other embodiments, the letter keys may be shaped differently.

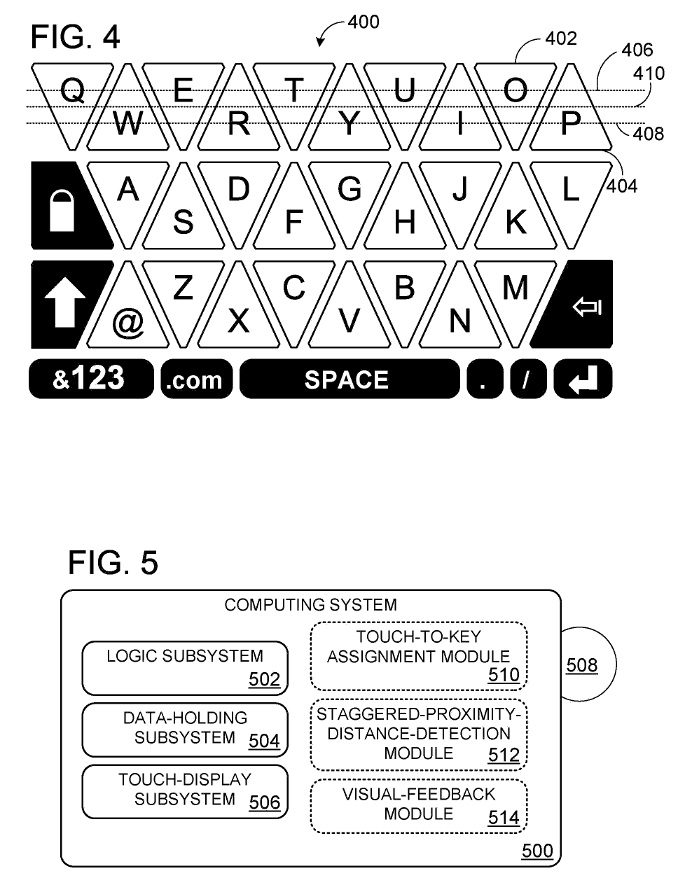

For example, FIG. 4 shows a virtual keyboard 400 arranged with a QWERTY key layout that utilizes generally-triangularly-shaped keys in a staggered arrangement. In particular, each row of staggered virtual-touch-input keys includes a first set of generally-triangularly-shaped keys (e.g., the Q-key, the E-key, the T-key, the U-key, and the O-key) having an upward-facing base (e.g., triangle base 402 of the O-key). Further, each row of staggered virtual-touch-input keys includes a second set of generally-triangularly-shaped keys (e.g., the W-key, the R-key, the Y-key, the I-key, and the P-key) having a downward-facing base (e.g., triangle base 404 of the P-key). The alternating orientations of the triangular keys allows the keys to be interlocked with one another, so that the bases of the first set of generally-triangularly-shaped keys may be aligned with the tips of the second set of generally-triangularly-shaped keys, and vice versa.

As shown in FIG. 4, a centroid of each generally-triangularly-shaped key from the first set is aligned with an upward offset 406, and a centroid of each generally-triangularly-shaped key from the second set is aligned with a downward offset 408. In the illustrated embodiments, the upward and downward offsets are set to allow a tight interlocking of the staggered keys. An average-row-line 410 may bisect both upward and downward facing triangular keys when such keys interlock tightly. The offsets may be increased without departing from the scope of this disclosure.

In some embodiments, the herein described methods and processes for visually presenting a virtual keyboard and/or processing touch input directed to the virtual keyboard may be tied to a computing system. As an example, FIG. 5 schematically shows a computing system 500 that may perform one or more of the herein described methods and processes. Computing system 500 includes a logic subsystem 502, a data-holding subsystem 504, and a touch-display subsystem 506.

Logic subsystem 502 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 504 may include one or more physical devices configured to hold data and/or instructions executable by the logic subsystem to implement the herein described methods and processes. When such methods and processes are implemented, the state of data-holding subsystem 504 may be transformed (e.g., to hold different data). Data-holding subsystem 504 may include removable media and/or built-in devices. Data-holding subsystem 504 may include optical memory devices, semiconductor memory devices, and/or magnetic memory devices, among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of computer-readable removable media 508, which may be used to store and/or transfer data and/or instructions executable to implement the herein described methods and processes.

Touch-display subsystem 506 may be used to present a visual representation of data held by data-holding subsystem 504 (e.g., present a virtual keyboard). As the herein described methods and processes change the data held by the data-holding subsystem, and thus transform the state of the data-holding subsystem, the state of touch-display subsystem 506 may likewise be transformed to visually represent changes in the underlying data. Furthermore, touch-display subsystem 506 may be used to recognize user input in the form of touches. Such touches may be positionally correlated to an image presented by the touch-display subsystem and assigned different meaning depending on the position of the touch. Touch-display subsystem 506 may include one or more touch-display devices utilizing virtually any type of display and/or touch-sensing technology. Such touch-display devices may be combined with logic subsystem 502 and/or data-holding subsystem 504 in a shared enclosure, or such touch-display devices may be peripheral touch-display devices.

Logic subsystem 502, data-holding subsystem 504, and touch-display subsystem 506 may cooperate to visually present a virtual keyboard with staggered keys. Furthermore, the logic subsystem and the data-holding subsystem may cooperate to form a touch-to-key assignment module 510, a staggered-proximity-distance-detection module 512, and/or a visual-feedback module 514.

The staggered-proximity-distance-detection module 512 may be configured to determine, for each virtual-touch-input key struck by a touch (e.g., from a user finger or other object), a staggered-proximity distance from the touch to an offset for that virtual-touch-input key.

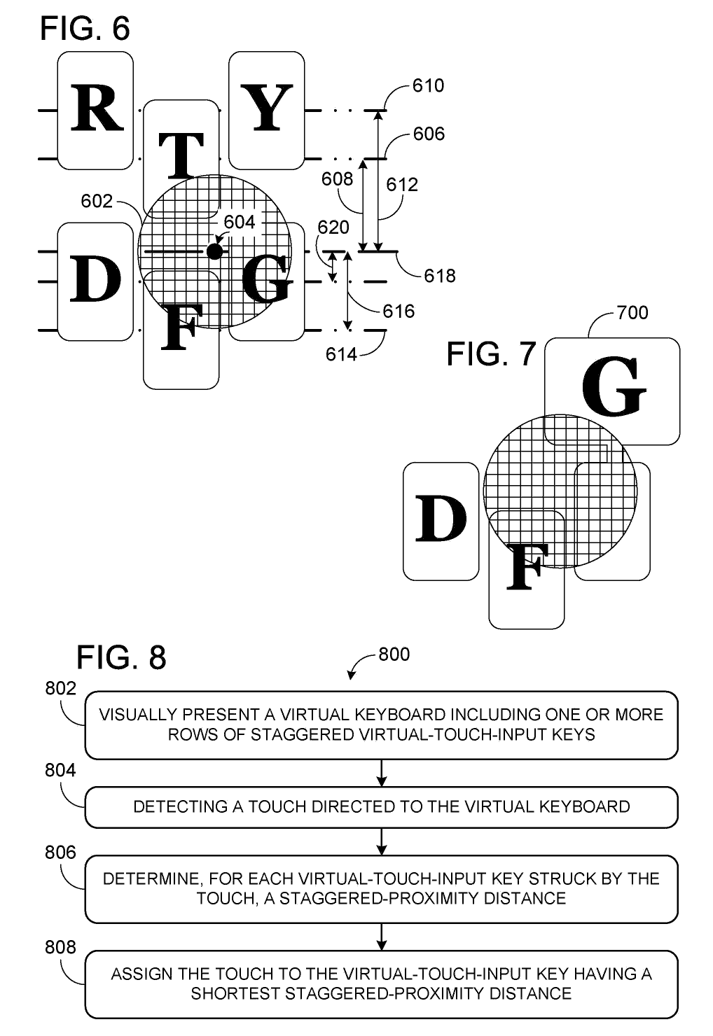

FIG. 6 somewhat schematically shows a touch-region 602 from a user touch, which a staggered-proximity-distance-detection module may use to calculate a staggered-proximity distance. In some embodiments, a touch region (e.g., touch region 602) may be resolved to a point (e.g., point 604), which may be a center of the touch region or another suitable position within the touch region.

The staggered-proximity distance for each key may be calculated as the distance between the offset to which that key is aligned and the point representing the touch region. For example, a distance between a resolved point 604 of a touch region and the downward offset 606 to which the T-key is aligned may be referred to as a staggered-proximity distance 608; a distance between the resolved point 604 of the touch region and the upward offset 610 to which the Y-key is aligned may be referred to as a staggered-proximity distance 612; a distance between the resolved point 604 of the touch region and the downward offset 614 to which the F-key is aligned may be referred to as a staggered-proximity distance 616; and a distance between the resolved point 604 of the touch region and the upward offset 618 to which the G-key is aligned may be referred to as a staggered-proximity distance 620.

A touch-to-key assignment module may be configured to assign a touch directed to the virtual keyboard and recognized by the touch display to a virtual-touch-input key. As an example, a touch-to-key assignment module may be configured to assign a touch to the virtual-touch-input key having a shortest staggered-proximity distance. Using FIG. 6 as an example, the G-key has the shortest staggered-proximity distance, and therefore the touch-to-key assignment module may assign a touch corresponding to touch region 602 to the G-key. In other words, a computing system can recognize a touch producing touch region 602 as a strike of the G-key.

In some embodiments, a touch-to-key assignment module may be configured to assign a touch to the virtual-touch-input key having a largest strike area from the touch. In some embodiments, a combination of strike area and staggered-proximity distance may be used.

In some embodiments, a touch-to-key assignment module may not assign a touch to a virtual-touch-input key until the touch is completed (e.g., a user lifts a finger from the touch display). Further, in some embodiments, a visual appearance of the key that is considered to be ready for selection (e.g., key with shortest staggered-proximity distance and/or largest strike area) may be changed to indicate that that key will be assigned the touch upon completion of the touch. For example, the key may be enlarged and/or shifted so that it may be more easily viewed by a user. FIG. 7 shows a nonlimiting example in which a modified G-Key 700 is shifted above a touch region and enlarged responsive to the touch region striking the G-key. As shown in FIG. 5, a computing system may include a visual-feedback module 514 configured to visually indicate that a staggered virtual-touch-input key is considered to be ready for selection.

FIG. 8 shows a method 800 of processing user input. At 802, method 800 includes visually presenting a virtual keyboard including one or more rows of staggered virtual-touch-input keys. As described above, each row of staggered virtual-touch-input keys may include a first set of keys aligned with a first offset and a second set of keys aligned with a second offset. Such keys may be rectangular, triangular, or any other suitable shape. At 804, method 800 includes detecting a touch directed to the virtual keyboard. At 806, method 800 includes determining, for each virtual-touch-input key struck by the touch, a staggered-proximity distance from the touch to an offset for that virtual-touch-input key. At 808, method 800 includes assigning the touch to the virtual-touch-input key having a shortest staggered-proximity distance from the touch to an offset for that virtual-touch-input key.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a touch display;
a virtual keyboard visually presented by the touch display, the virtual keyboard including one or more rows of staggered virtual-touch-input keys;
a touch-to-key assignment module configured to assign a touch directed to the virtual keyboard and recognized by the touch display to a virtual-touch-input key.

2. The computing system of claim 1, where each row of staggered virtual-touch-input keys includes a first set of keys aligned with a first offset and a second set of keys aligned with a second offset.

3. The computing system of claim 2, further comprising a staggered-proximity-distance-detection module configured to determine, for each virtual-touch-input key struck by the touch, a staggered-proximity distance from the touch to an offset for that virtual-touch-input key.

4. The computing system of claim 3, where the touch-to-key assignment module is configured to assign the touch to the virtual-touch-input key having a shortest staggered-proximity distance.

5. The computing system of claim 2, where each row of staggered virtual-touch-input keys further includes a third set of keys aligned with a third offset.

6. The computing system of claim 1, where one or more staggered virtual-touch-input keys are generally-rectangularly-shaped.

7. The computing system of claim 1, where the touch-to-key assignment module is configured to assign the touch to the virtual-touch-input key having a largest strike area from the touch.

8. The computing system of claim 1, where one or more rows of staggered virtual-touch-input keys are straight rows.

9. The computing system of claim 1, where one or more rows of staggered virtual-touch-input keys are arced rows.

10. The computing system of claim 1, where each row of staggered virtual-touch-input keys includes a first set of generally-triangularly-shaped keys having an upward-facing base and a second set of generally-triangularly-shaped keys having a downward-facing base.

11. The computing system of claim 10, where the first set of generally-triangularly-shaped keys has an upward offset as measured from a centroid of each key and the second set of generally-triangularly-shaped keys has a downward offset as measured from a centroid of each key.

12. The computing system of claim 11, where the first set of generally-triangularly-shaped keys is aligned with the second set of generally-triangularly-shaped keys.

13. The computing system of claim 1, where the virtual keyboard includes:
a top row comprising a left-to-right arrangement of a Q-key, a W-key, an E-key, an R-key, a T-key, a Y-key, a U-key, an I-key, an O-key, and a P-key;
a middle row comprising a left-to-right arrangement of an A-key, an S-key, a D-key, an F-key, a G-key, an H-key, a J-key, a K-key, and an L-key; and
a bottom row comprising a left-to-right arrangement of a Z-key, an X-key, a C-key, a V-key, a B-key, an N-key, and an M-key.

14. The computing system of claim 13, where the Q-key, the E-key, the T-key, the U-key, the O-key, the S-key, the F-key, the H-key, the K-key, the Z-key, the C-key, the B-key, and the M-key are aligned with a downward offset.

15. The computing system of claim 1, further comprising a visual-feedback module configured to visually indicate that a staggered virtual-touch-input key is considered to be ready for selection.

16. A handheld computing system, comprising:
a touch display;
a logic subsystem operatively coupled to the touch display; and
a data-holding subsystem holding instructions executable by the logic subsystem to:
visually present a virtual keyboard with the touch display, the virtual keyboard including one or more rows of staggered virtual-touch-input keys, each row of staggered virtual-touch-input keys including a first set of keys aligned with a first offset and a second set of keys aligned with a second offset;
detect a touch directed to the virtual keyboard;
determine, for each virtual-touch-input key struck by the touch, a staggered-proximity distance from the touch to an offset for that virtual-touch-input key; and
assign the touch to the virtual-touch-input key having a shortest staggered-proximity distance.

17. The handheld computing system of claim 16, where one or more staggered virtual-touch-input keys are generally-rectangularly-shaped.

18. The handheld computing system of claim 16, where each row of staggered virtual-touch-input keys includes a first set of generally-triangularly-shaped keys having an upward-facing base and a second set of generally-triangularly-shaped keys having a downward-facing base.

19. The handheld computing system of claim 16, where the virtual keyboard includes:
a top row comprising a left-to-right arrangement of a Q-key, a W-key, an E-key, an R-key, a T-key, a Y-key, a U-key, an I-key, an O-key, and a P-key;
a middle row comprising a left-to-right arrangement of an A-key, an S-key, a D-key, an F-key, a G-key, an H-key, a J-key, a K-key, and an L-key; and
a bottom row comprising a left-to-right arrangement of a Z-key, an X-key, a C-key, a V-key, a B-key, an N-key, and an M-key.

20. A method of processing user input, the method comprising:
visually presenting a virtual keyboard including one or more rows of staggered virtual-touch-input keys, each row of staggered virtual-touch-input keys including a first set of keys aligned with a first offset and a second set of keys aligned with a second offset;
detecting a touch directed to the virtual keyboard;
determining, for each virtual-touch-input key struck by the touch, a staggered-proximity distance from the touch to an offset for that virtual-touch-input key; and
assigning the touch to the virtual-touch-input key having a shortest staggered-proximity distance from the touch to an offset for that virtual-touch-input key.
